(19) United States
(12) Patent Application Publication
(10) Pub. No.: US 2026/0241768 A1
(43) Pub. Date: Aug. 20, 2026

(54) VEHICLE AIR VENTILATION SYSTEM

(71) Applicant: Marelli North America, Inc., Southfield, MI (US)

(72) Inventors: Sanjeeva Rao PALAKA, Novi, MI (US); Ratheesh KIZHAKKE VALAPPIL, Novi, MI (US); Abraham CAMACHO-MONTOYA, Farmington Hills, MI (US); Ashley TENNANT, Livonia, MI (US); Alfredo LOPEZ, Aguascalientes (MX); Alicia LANDEROS, Aguascalientes (MX); Michael MILLER, Southfield, MI (US); Alan Emmanuel AQUINO, Aguascalientes (MX); Josue Eduardo DE LUNA, Aguascalientes (MX); Justin BERRY, Owosso, MI (US)

(21) Appl. No.: 19/563,040

(22) Filed: Mar. 11, 2026

Related U.S. Application Data
(63) Continuation-in-part of application No. 18/935,807, filed on Nov. 4, 2024, now abandoned.

(51) Int. Cl. B60H 1/00; B60H 1/34

(52) U.S. Cl. CPC B60H 1/00871; B60H 1/00742; B60H 1/3421; B60H 2001/3471

(57) ABSTRACT

A vehicle air ventilation system is configured to control air flowing into a passenger compartment of a vehicle. The vehicle air ventilation system includes an airduct assembly, an airflow-adjusting member, an actuator unit, a contactless sensor, and a control unit. The air duct assembly defines an air duct and a vent opening through which air flows from the air duct into the passenger compartment. The airflow-adjusting member is coupled to the air duct assembly, and configured to adjust an airflow from the air duct into the passenger compartment. The actuator unit is operatively coupled to the airflow-adjusting member to control the airflow-adjusting member to adjust the airflow. The contactless sensor is configured to detect a gesture of a hand located within a prescribed region adjacent to the vent opening in the passenger compartment, and to output a detection signal indicative of the gesture. The control unit is configured to receive the detection signal and to control the actuator unit to move the airflow-adjusting member to adjust the airflow based on the gesture detected by the contactless sensor.

### CROSS-REFERENCE TO RELATED APPLICATIONS

This application is a continuation-in-part application of U.S. patent application Ser. No. 18/935,807 filed on Nov. 3, 2024. The entire disclosure of U.S. patent application Ser. No. 18/935,807 is hereby incorporated herein by reference.

### BACKGROUND

### Technical Field

The present disclosure generally relates to a vehicle air ventilation system. More specifically, the present disclosure relates to a vehicle air ventilation system that is configured to control air flowing into a passenger compartment of a vehicle.

### Background Information

The vehicle is equipped with an on-board air conditioner. The air from the air conditioner is directed into the passenger compartment through the ventilation path and air vent. Louvers and fins are provided in the ventilation path, and their positions can be adjusted to control the direction of the airflow, allowing it to be directed toward a prescribed direction with respect to a horizontal direction and/or a vertical direction.

### SUMMARY

The present disclosure is directed to various features of a vehicle ventilation system.

In view of the state of the known technology, one aspect of the present disclosure is to provide a vehicle air ventilation system that is configured to control air flowing into a passenger compartment of a vehicle. The vehicle air ventilation system includes an airduct assembly, an airflow-adjusting member, an actuator unit, a contactless sensor, and a control unit. The air duct assembly defines an air duct and a vent opening through which air flows from the air duct into the passenger compartment. The airflow-adjusting member is coupled to the air duct assembly, and configured to adjust an airflow from the air duct into the passenger compartment. The actuator unit is operatively coupled to the airflow-adjusting member to control the airflow-adjusting member to adjust the airflow. The contactless sensor is configured to detect a gesture of a hand located within a prescribed region adjacent to the vent opening in the passenger compartment, and to output a detection signal indicative of the gesture. The control unit is configured to receive the detection signal and to control the actuator unit to move the airflow-adjusting member to adjust the airflow based on the gesture detected by the contactless sensor.

In view of the state of the known technology, another aspect of the present disclosure is to provide a non-transitory computer-readable storage medium operatively coupled to the processor, the computer-readable storage medium comprising computer-executable instructions that, when executed by the processor, cause the processor to: receive a detection signal from a contactless sensor, the detection signal being indicative of a gesture of a hand located within a prescribed region adjacent to a vent opening in a passenger compartment of a vehicle; and activate an actuator unit to move an airflow-adjusting member coupled to an air duct assembly of the vehicle to adjust an airflow from an air duct to the passenger compartment according to the gesture.

Also other features, aspects and advantages of the disclosed vehicle air ventilation system will become apparent to those skilled in the field of manufacturing vehicles from the following detailed description, which, taken in conjunction with the annexed drawings, discloses an illustrative embodiment of a vehicle with various features.

### BRIEF DESCRIPTION OF THE DRAWINGS

Referring now to the attached drawings which form a part of this original disclosure:

FIG. 1 is a perspective view of an instrument panel of a vehicle equipped with a vehicle air ventilation system in accordance with a first embodiment;

FIG. 2 is an elevational view of a part of the instrument panel illustrated in FIG. 1;

FIG. 3 is a perspective view of the part of the instrument panel illustrated in FIG. 1;

FIG. 4 is a perspective view of an air duct assembly of the vehicle air ventilation system in accordance with the first embodiment;

FIG. 5 is a cross-sectional view taken along the line V-V in FIG. 2;

FIG. 6 is a block diagram illustrating control components of the vehicle air ventilation system in accordance with the first embodiment;

FIG. 7 is a schematic diagram for explaining the field of view of one example of a contactless sensor of the vehicle air ventilation system in accordance with the first embodiment;

FIG. 8 is a flowchart of an airflow direction adjustment control executed by a control unit of the vehicle air ventilation system in accordance with the first embodiment;

FIGS. 9A-9D are schematic diagrams showing how the airflow direction is adjusted in the vehicle air ventilation system in accordance with the first embodiment;

FIG. 10 is a flowchart for generating a machine-learned recognition model in accordance with the first embodiment;

FIG. 11 is an elevational view of an instrument panel of a vehicle equipped with a vehicle air ventilation system in accordance with a second embodiment;

FIG. 12 is an enlarged elevational view of the vehicle air ventilation system illustrated in FIG. 11;

FIG. 13 is a side view of the vehicle air ventilation system illustrated in FIG. 12;

FIG. 14 is a block diagram illustrating control components of the vehicle air ventilation system in accordance with the second embodiment;

FIG. 15 is a partial elevational view of the vehicle air ventilation system illustrating the operation of a linkage mechanism in accordance with the second embodiment;

FIG. 16 is a partial elevational view of the vehicle air ventilation system illustrating the operation of the linkage mechanism in accordance with the second embodiment;

FIG. 17 is a cross-sectional view of the vehicle air ventilation system illustrating the operation of a cam mechanism in accordance with the second embodiment;

FIG. 18 is a cross-sectional view of the vehicle air ventilation system illustrating the operation of the cam mechanism in accordance with the second embodiment;

FIG. 19 is a cross-sectional view of the vehicle air ventilation system illustrating the operation of the cam mechanism in accordance with the second embodiment;

FIG. 20 is a cross-sectional view of the vehicle air ventilation system illustrating the operation of the cam mechanism in accordance with the second embodiment;

FIG. 21A is a block diagram illustrating a part of an airflow direction adjustment control executed by a control unit of the vehicle air ventilation system in accordance with the second embodiment;

FIG. 21B is a block diagram illustrating a part of the airflow direction adjustment control executed by a control unit of the vehicle air ventilation system in accordance with the second embodiment;

FIG. 22 is a cross sectional view as taken along a line A-A in FIG. 12 illustrating how the airflow direction is adjusted in the vehicle air ventilation system in accordance with the second embodiment;

FIG. 23 is a cross sectional view as taken along the line A-A in FIG. 12 illustrating how the airflow direction is adjusted in the vehicle air ventilation system in accordance with the second embodiment;

FIG. 24 is a cross sectional view as taken along a line B-B in FIG. 12 illustrating how the airflow direction is adjusted in the vehicle air ventilation system in accordance with the second embodiment;

FIG. 25 is a cross sectional view as taken along the line B-B in FIG. 12 illustrating how the airflow direction is adjusted in the vehicle air ventilation system in accordance with the second embodiment;

FIG. 26 is a cross sectional view as taken along the line B-B in FIG. 12 illustrating how the airflow direction is adjusted in the vehicle air ventilation system in accordance with the second embodiment; and

FIG. 27 is a cross sectional view as taken along the line B-B in FIG. 12 illustrating how the airflow direction is adjusted in the vehicle air ventilation system in accordance with the second embodiment.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment, and should not be interpreted as defining or limiting the range of values or properties encompassed by illustrative embodiments unless specified. The use of similar or identical reference numbers in the various drawings is intended to indicate the presence of a similar or identical element or feature.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents. Like reference numerals in the drawings denote like similar or identical elements or features, and thus, the descriptions of the similar or identical elements or features may be omitted in later embodiments.

### First Embodiment

Referring to the attached drawings, a vehicle air ventilation system according to a first embodiment of the present disclosure will be described. The vehicle air ventilation system is configured to control air flowing into a passenger compartment of a vehicle.

In the attached drawings illustrating embodiments of the present disclosure, the X direction is the front-and-rear (longitudinal) direction of the vehicle where the +X direction represents the direction from the front to the rear of the vehicle. The Y direction is the left-and-right (width/lateral) direction of the vehicle where the +Y direction represents the direction from right to left of the vehicle. The Z direction is the up-and-down (vertical) direction of the vehicle where the +Z direction represents the direction from the bottom to the top of the vehicle.

The vehicle air ventilation system according to the first embodiment includes an air duct assembly 2, an airflow-adjusting member 3, an actuator unit 4, a contactless sensor 5, and a control unit 6.

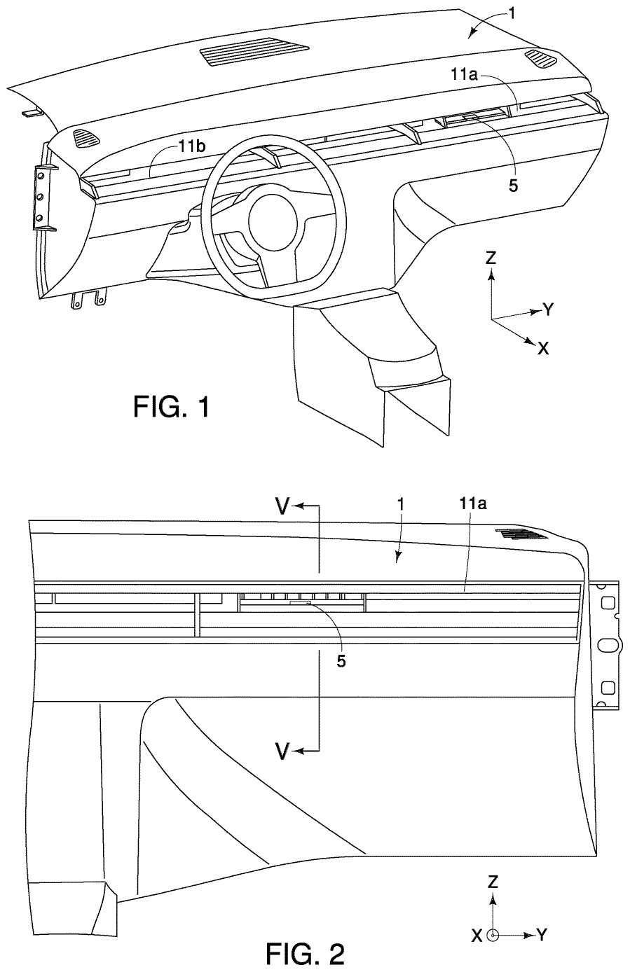

As shown in FIGS. 1 to 3, the passenger compartment of the vehicle includes an instrument panel 1. In this example, the instrument panel 1 defines a pair of air vent openings 11a and 11b on the left side and the right side in the front portion of the passenger compartment. Each of the air vent openings 11a and 11b is an elongated narrow opening generally extending in the horizontal direction (Y direction). The instrument panel 1 may be provided with one or more additional air vent openings. Although not shown, the additional air vent opening(s) may also be provided near the back seats of the vehicle.

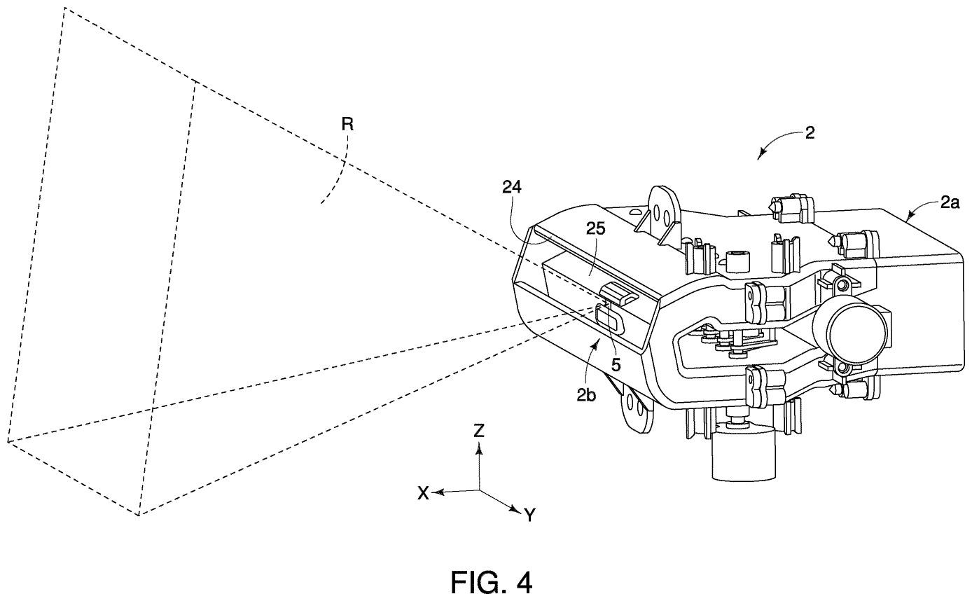

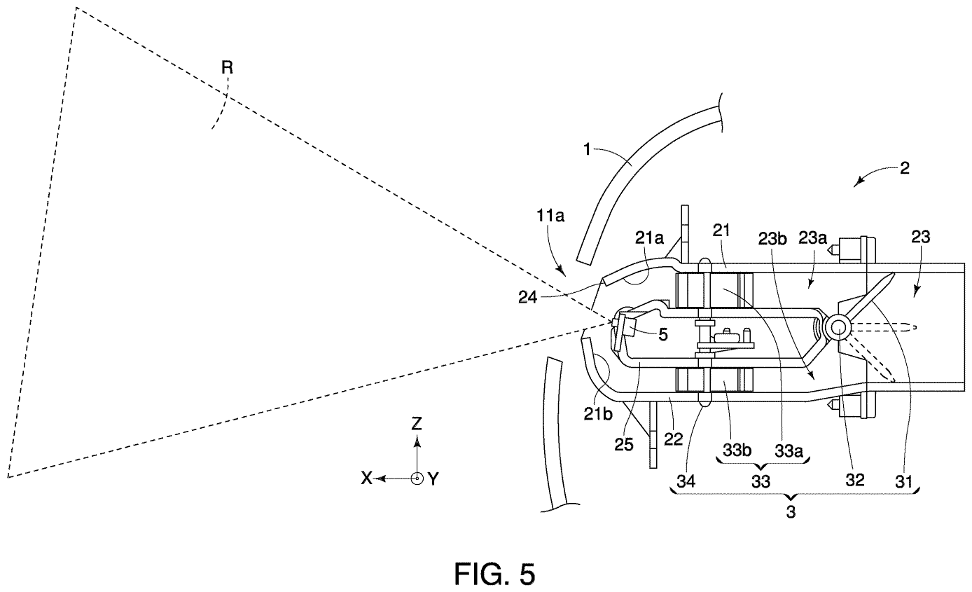

As shown in FIGS. 4 and 5, in the vehicle air ventilation system of the first embodiment, the air duct assembly 2 is arranged behind each of the air vent openings 11a and 11b. The air duct assemblies 2 provided behind the air vent openings 11a and 11b have identical basic structures. Therefore, this disclosure will only provide a detailed explanation of the air duct assembly 2 located behind the air vent opening 11a.

FIGS. 4 and 5 show an example of the air duct assembly 2 according to the first embodiment. The air duct assembly 2 extends between an inlet end 2a into which a volume of air is directed in an initial air flow direction, and an outlet end 2b at which the volume of air exits the air duct assembly 2. The inlet end 2a of the air duct assembly 2 is connected to a vehicle's HVAC system (not shown), which regulates the temperature, humidity, and other air conditions. The conditioned air from the vehicle's HVAC system is then directed into the passenger compartment through the air duct assembly 2.

The air duct assembly 2 includes a housing with an upper wall 21 and a bottom wall 22. An air duct 23 through which the air flows generally in the +X direction from the inlet end 2a to the outlet end 2b is defined between the upper wall 21 and the bottom wall 22 of the housing. The air duct assembly 2 further defines an outlet opening 24 at the outlet end 2b through which air flows from the air duct 23 into the passenger compartment. The outlet opening 24 of the air duct assembly 2 at least partially overlaps the air vent opening 11a of the instrument panel 1 when viewed along the X direction.

As shown in FIG. 5, the air duct assembly 2 includes a partition part 25 disposed upstream of the outlet opening 24 with respect to the direction of the airflow in the air duct 23. The partition part 25 has an upstream end portion 25a and a downstream end portion 25b. The partition part 25 divides an airway in the air duct 23 into a first channel 23a and a second channel 23b. More specifically, the first channel 23a is defined between the upper wall 21 and an upper surface of the partition part 25, and the second channel 23b is defined between a lower surface of the partition part 25 and the bottom wall 22. In the first embodiment, the first channel 23a and the second channel 23a are aligned vertically (along the Z direction). It will be understood that, although the first channel 23a and the second channel 23b are illustrated as being in a vertical relationship to each other (i.e., upper and lower channels respectively), they may also be positioned in any other relationship to each other in accordance with the design considerations of the instrument panel 1 and the air vent opening 11a.

The upper wall 21 of the air duct assembly 2 has a first inclined surface 21a, which is inclined downwardly toward the outlet opening 24. The bottom wall 22 of the air duct assembly 2 has a second inclined surface 22a, which is inclined upwardly toward the outlet opening 24. Each of the first inclined surface 21a and the second inclined surface 22a partially overlaps the partition part 25 when viewed in the Z direction. In other words, the first inclined surface 21a defines a part of a downstream portion of the first channel 23a, and the second inclined surface 22a defines a part of a downstream portion of the second channel 23b.

In the first embodiment, the air duct assembly 2 is configured such that the air flows in the initial air flow direction generally along the +X direction in a region between the inlet end 2a and an upstream portion of the partition part 25, and diverges into the first channel 23a and the second channel 23b. The airflow entering the first channel 23a is directed horizontally, then directed downwardly towards the outlet opening 24 after hitting the first inclined surface 21a. The airflow entering the second channel 23b is directed horizontally, then directed upwardly towards the outlet opening 24 after hitting the second inclined surface 21a. The airflow from the first channel 23a and the airflow from the second channel 23b marge together downstream of the partition part 25. The merged airflow then exits through the outlet opening 24 and is blown into the passenger compartment through the air vent opening 11a of the instrument panel 1. With respect to the vertical direction, the direction (angle) of the merged airflow exiting the outlet opening 24 changes based on the distribution of the air volumes (pressures) from the first channel 23a and the second channel 23b. This configuration enables the air vent opening 11a of the instrument panel 1 to have a relatively narrow slit shape, eliminating the need for vanes or louvers at the opening. As a result, the aesthetic appeal of instrument panel 1 is enhanced.

The vehicle air ventilation system 1 further includes an airflow-adjusting member 3 coupled to the air duct assembly 2. The airflow-adjusting member 3 is configured to adjust the airflow from the air duct 22 into the passenger compartment.

More specifically, the airflow-adjusting member 3 includes an airflow-directing part 31 movably coupled to the upstream end portion 25a of the partition part 25 of the air duct assembly 2. The airflow-directing part 31 is configured to adjust a volume of the airflow directed into each of the first channel 23a and the second channel 23b. More specifically, the airflow-directing part 31 is a louver member having a base end and a tip end. The airflow-directing part 31 is pivotable or rotatable about a rotational shaft 32 at the base portion of the airflow-directing part 31. In the first embodiment, the rotational shaft 32 extends in the Y direction. The airflow-directing part 31 is movable between a first position, in which a tip of the airflow-directing part 31 is located at a predetermined minimum distance from the bottom wall 22, and a second position, in which the tip of the airflow-directing part 31 is located at a predetermined minimum distance from the upper wall 21. When the airflow-directing part 31 is in its first position, a major portion of the volume of air flowing into the inlet end 2a is directed into the first channel 23a. When the airflow-directing part 31 is in its second position, a major portion of the volume of air flowing into the inlet end 2a is directed into the second channel 23b. The airflow-directing part 31 may also be positioned at any intermediate position between the first and second positions. By adjusting the position of the airflow-directing part 31 between the first position and the second position, the volume of the air directed to each of the first channel 23a and the second channel 23b is adjusted. This allows for adjusting the airflow direction of the air exiting from outlet opening 24 towards the desired angle relative to the vertical direction.

The airflow-adjusting member 3 of the first embodiment further includes a plurality of vertically extending vane parts 33 attached to the partition part 25 of the air duct assembly. The vane parts 33 are rotationally attached to the partition part 25 at a position between the upstream end portion 25a and the downstream end portion 25b of the partition part 25. Each of the vane parts 33 includes a first vane section 33a disposed within the first channel 23a, and a second vane section 33b disposed within the second channel 23b. Each of the vane parts 33 is secured to the partition part 25 via a rotational shaft 34 allowing both the first vane section 33a and the second vane section 33b to pivot together relative to the partition part 25. In the first embodiment, the rotational shaft 34 extends in the Z direction. The vane parts 33 are configured to direct the airflow generally to left or right, or any intermediate direction therebetween as the air exits the outlet opening 24. In other words, by adjusting the position of the vane parts 33, the airflow direction of the air exiting from the outlet opening 24 can be adjusted in the desired direction with respect to the horizontal direction.

In the first embodiment, the vane parts 33 are located a predetermined distance upstream from the outlet end 2b of the air duct assembly 2, so that the vane parts 33 are at least partially concealed by the housing of the air duct assembly 2. Therefore, the vane parts 33 can be at least partially concealed from the user in the passenger compartment of the vehicle. As a result, the aesthetic appeal of instrument panel 1 is enhanced.

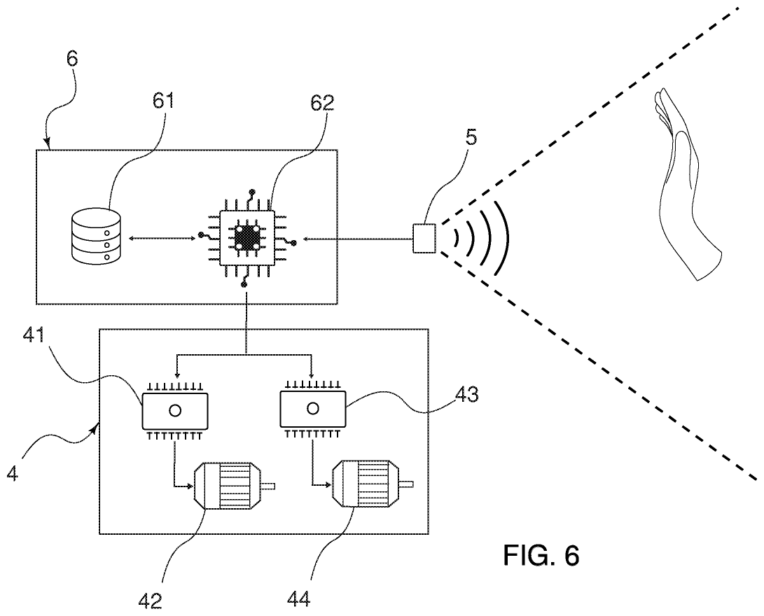

The actuator unit 4 is operatively coupled to the airflow-adjusting member 3 to adjust the airflow. More specifically, as shown in FIG. 6, the actuator unit 4 includes a first motor driver 41 and a first motor 42 and a second motor driver 43 and a second motor 44. The first motor driver 41 is operatively coupled to the first motor 42, which is operatively coupled to the rotational shaft 32 of the airflow-directing part 31. The second motor driver 43 is operatively coupled to the second motor 44, which is operatively coupled to the rotational shaft 34 of the vane parts 33. In the first embodiment, the first motor 42 and the second motor 44 are stepper motors to enable precise control of the positions of the airflow-directing part 31 and the vane units 33. However, a conventional motor other than a stepper motor may be used as the first motor 42 or the second motor 44 as long as the position adjustment of the airflow-directing part 31 and the vane units 33 can be sufficiently executed by controlling the motor. Moreover, other types of conventional actuator mechanisms, rather than a rotational motor, may be utilized to control the airflow-directing part 31 and the vane units 33.

In the vehicle air ventilation system according to the first embodiment, the contactless sensor 5 is mounted within the duct assembly 2. More specifically, the contactless sensor 5 is mounted within the outlet opening 24 at the downstream end portion 25b of the partition part 25 of the air duct assembly 2. The contactless sensor 5 is mounted on an end surface at the downstream end portion 25b of the partition part 25 that faces toward the passenger compartment. In other words, the contactless sensor 5 is mounted at a position downstream of the vane parts 33 and upstream of the outlet opening 24 with respect to the airflow direction. Since the contactless sensor 5 is mounted within the outlet opening 24 at a position downstream of the vane parts 33, the field of view of the contactless sensor 5 is prevented from being obstructed by the vane parts 33.

The contactless sensor 5 is configured to detect the position of an object within a prescribed region R, which is adjacent to the outlet opening 24 in the passenger compartment. The prescribed region R is defined so that the contactless sensor 5 can identify objects placed near the air vent opening 11a of the instrument panel 1. For example, the prescribed region R encompasses an area of approximately 25 cm from the contactless sensor 5. The dimension of the prescribed region R can be adjusted according to the design requirements and consideration of the vehicle.

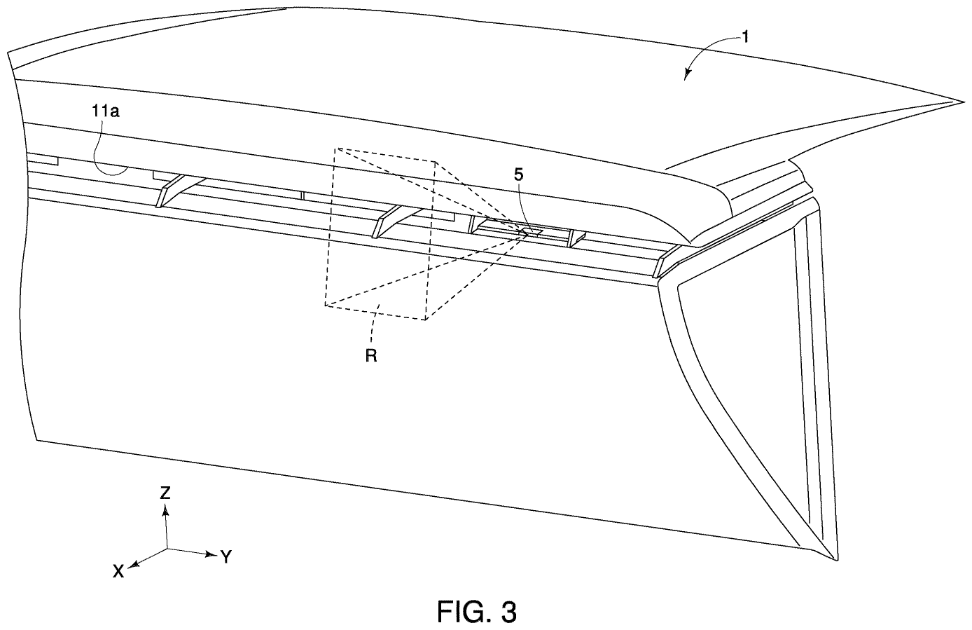

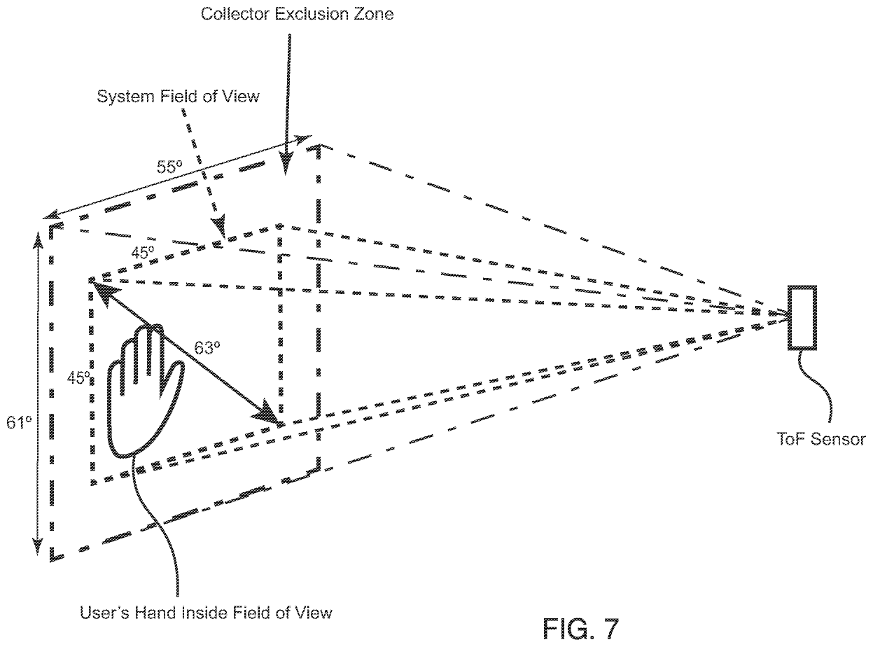

In the first embodiment, the contactless sensor 5 is a time-of-flight (ToF) ranging sensor that measures the distance to the object by calculating the time it takes for a light pulse to travel to the object and back. In the first embodiment, the ToF sensor includes an emitter such as a vertical-cavity surface-emitting laser (VCSEL) and a SPAD (single photon avalanche diode) array housed in a miniature package. The SPAD array consists of multiple SPAD elements arranged in a grid. This array enables the ToF sensor to detect the light returning from different spatial regions of the scene, effectively capturing a 3D depth map. The ToF sensor allows a square field of view to be projected into the prescribed region R in the passenger compartment as shown in FIGS. 3 and 4. The FIG. 7 schematically illustrates one example of the system field of view (FOV) and exclusion zone of the ToF sensor. The FOV shown in FIG. 7 describes one example of the angular extent of the observable area that the ToF sensor can measure, which determines how wide or narrow the sensor's detection capabilities are. A wider FOV allows the sensor to capture reflections from a larger area, while a narrower FOV can focus on a specific target with higher precision. The system's FOV is designed to optimize the distance measurements while minimizing interference from surrounding objects. The collector exclusion zone shown in FIG. 7 refers to the area around the sensor where it does not effectively collect reflected light. The collector exclusion zone helps prevent close-range interference, while the system FOV defines how broadly or narrowly the sensor can detect distance measurements. The detection volume in the FOV angles in FIG. 7 is an example when the target was located at 1 m from the ToF sensor.

In the first embodiment, using the time-of-flight sensor as the contactless sensor 5 can lead to several technical improvements, as explained below, compared to the prior art system equipped with different types of sensors, such as traditional image sensors (cameras) and infrared sensors.

Unlike standard cameras that capture 2D images, the ToF sensor measures the distance to object(s) by calculating the time it takes for a light signal to return after reflecting off surfaces. This allows the ToF sensor to create an accurate 3D representation of the scene without the need for complex algorithms, such as those required in stereo vision systems used by standard cameras, which analyze multiple images to extract depth information. As a result, the ToF sensor reduces processing complexity and resource requirements, enabling faster data acquisition and interpretation. In contrast, while infrared cameras can provide some depth information through techniques like stereovision, they often lack the precision and real-time capabilities of ToF sensors.

Moreover, the ToF sensor is less susceptible to lighting conditions, which is a significant advantage over both traditional cameras and infrared cameras. Standard cameras require good lighting to produce clear images, and infrared cameras can face challenges in bright sunlight or reflective environments. ToF sensors, however, can function effectively in various lighting conditions, providing consistent performance regardless of ambient light. Thus, the ToF sensor can effectively detect the object even in dynamic environments such as the passenger compartment of a vehicle where lighting can change rapidly.

Furthermore, the ToF sensors can provide depth data with low latency. While cameras can capture high-resolution images, processing these images to extract depth information can be computationally intensive and time-consuming. In contrast, the ToF sensor can deliver depth information almost instantaneously, facilitating real-time applications such as hand and gesture recognition.

Additionally, ToF sensors are relatively simple and compact, which makes them easy to mass-produce. This can result in lower costs of manufacturing the vehicle air ventilation system. In the example provided, a ToF sensor with a low resolution (e.g., 8×8) can be effectively used in conjunction with a machine-learned recognition model to detect objects, as explained in more detail below. This approach also leads to cost savings in manufacturing compared to traditional systems that rely on higher-resolution cameras or infrared sensors.

The control unit 6 is configured to determine whether the object detected by the contactless sensor 5 is a part of a human limb based on output data from the contactless sensor 5. The control unit 6 is configured to activate the actuator unit 4 to move the airflow-adjusting member 3 to adjust the airflow when the control unit 6 determines that the object is the part of the human limb. More specifically, in the first embodiment, the control unit 6 is configured to determine the object detected by the contactless sensor 5 is a hand of a user, and the control unit 6 is configured to control the actuator unit 4 to move the airflow-directing part 31 to direct the airflow toward the hand of the user.

In the first embodiment, the control unit 6 includes an electronic control unit or controller 61 (e.g., a processor) and a computer memory 62. The electronic controller 61 includes one or more processor(s) for controlling the various operations of the vehicle air ventilation system, as will be further described. In the first embodiment, the electronic controller 61 is preferably a microcontroller including a microcomputer (MPU) or central processing unit (CPU). The electronic controller 61 is formed of one or more semiconductor chips that are mounted on a circuit board. The term “electronic control unit” or “electronic controller” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 61.

The computer memory 62 is any memory or storage device. Here, for example, the computer memory 62 includes a transitory or non-transitory computer-readable medium with the sole exception of a transitory propagating signal. Thus, the computer memory 62 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The computer memory 62 stores various control processes or control programs as well as information or data used by the electronic controller 61. Thus, the computer memory 62 is electrically connected to the electronic controller 61. In this way, the electronic controller 61 can retrieve data and access programs stored in the computer memory 62, and can store data to the computer memory 62. As explained below, the computer memory 62 preferably includes non-volatile memory that is configured to store various control programs (e.g., a program for an airflow adjustment control method, etc.), operational data, component identification data, etc.

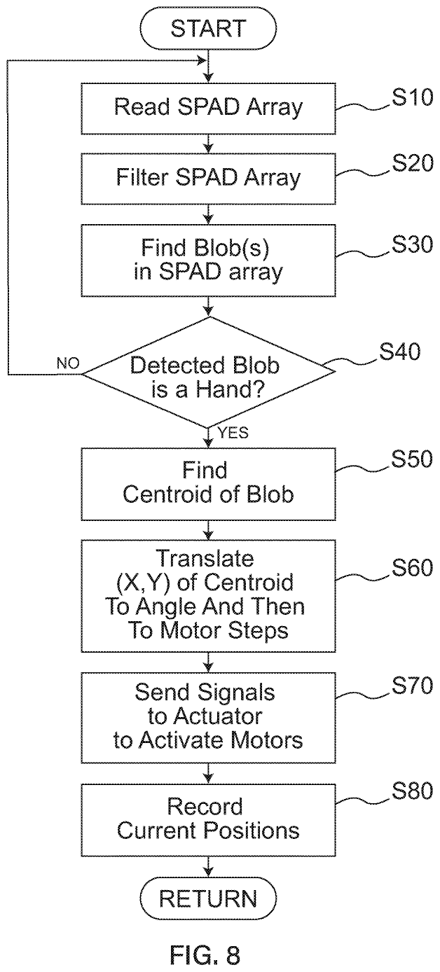

FIG. 8 is a flowchart of an airflow adjustment control executed by the control unit 6.

In step S10, the control unit 6 reads an output (SPAD array) from the contactless sensor 5.

In step S20, the control unit 6 filters the output data read in step S10 by, for example, setting a threshold.

In step S30, the control unit 6 identifies groups of pixels (“blob(s)”) in the depth map that represent distinct objects. Blobs are essentially clusters of pixels that share similar properties, such as depth or intensity.

In step S40, the control unit 6 determines whether the blob identified in the step S30 is a human hand. The control unit 6 performs hand recognition by applying the machine-learned hand recognition model stored in the computer memory 62. When the control unit 6 determines that the blob is not a human hand (step S40: No), the process returns to step S10. When the control unit 6 identifies the blob as a human hand (step S40: Yes), the control unit 6 proceeds to step S50.

In step S50, the control unit 6 finds a centroid of the identified blob.

In step S60, the control unit 6 translates the coordinates (X, Y) of the centroid of the blob into angles. Then, the control unit 6 translates the calculated angles to corresponding motor steps required to move the airflow-directing part 31 and the vane units 33 from the current positions to direct the airflow toward the hand.

In step S70, the control unit 6 controls the actuator unit 4 to rotate the first motor 42 and the second motor 44 by the corresponding steps calculated in step S60.

Therefore, the positions of the airflow-directing part 31 and the vane parts 33 are moved to direct the airflow toward the centroid of the blob, which represents the center of the hand.

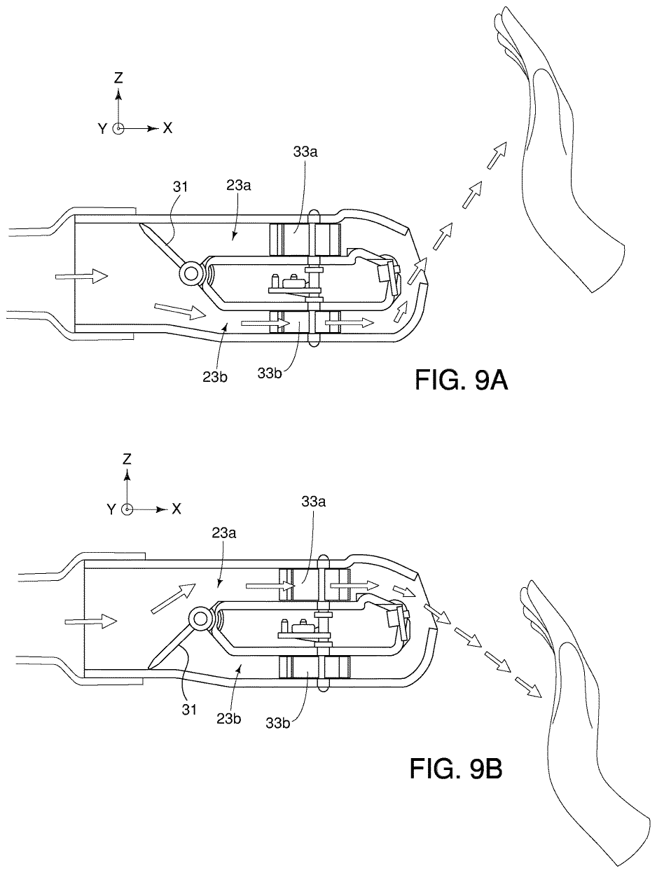

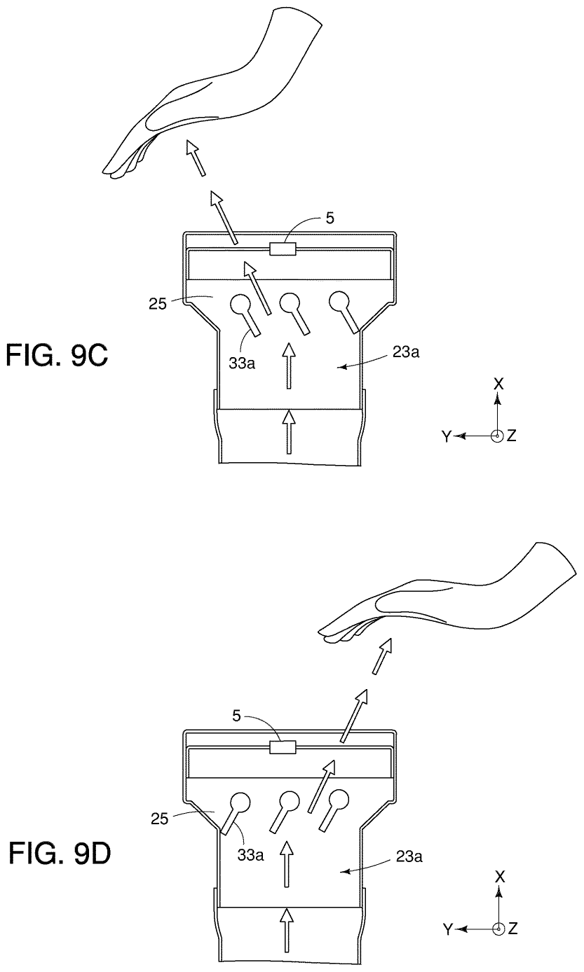

FIGS. 9A to 9D schematically show changing the positions of the airflow-directing part 31 and the vane parts 33 to direct the airflow toward the user's hand detected by the control unit 6. As shown in FIGS. 9A and 9B, the vertical angle of the airflow direction is changed by adjusting the position (angle) of the airflow-directing part 31. As shown in FIGS. 9C and 9D, the horizontal angle of the airflow direction is changed by adjusting the position (angle) of the vane parts 33.

In step S80, the control unit 6 records the current positions of the airflow-directing part 31 and the vane parts 33.

In step S40, the control unit 6 is configured to determine whether the object detected by the contactless sensor 5 is a human hand by applying a machine-learned recognition model to the output data from the contactless sensor 5. In the first embodiment, the user's hand is identified using a machine-learned recognition model. This allows for the use of a contactless sensor with a relatively lower resolution (e.g., 8×8), leading to cost savings in manufacturing compared to traditional systems using higher-resolution cameras or infrared sensors. Additionally, the machine-learned recognition model reduces real-time processing complexity during the operation of the vehicle air ventilation system, achieving a technical improvement over the prior art system.

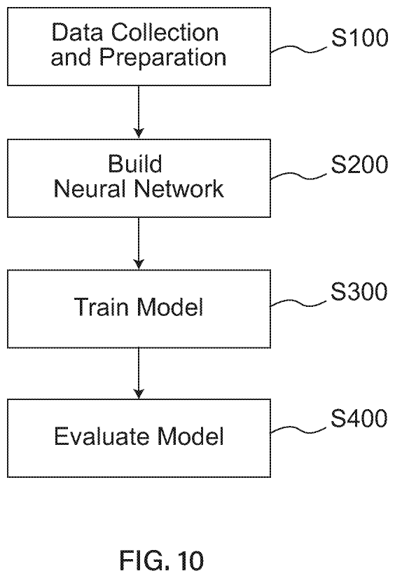

The machine-learned recognition model is pre-developed and stored in the memory 62 of the control unit 6 in advance. The recognition model can be created by employing deep learning techniques through the use of a neural network. This approach allows the machine-learned model to effectively analyze and interpret data patterns, enhancing its ability to recognize and categorize information with high accuracy. FIG. 10 illustrates a flowchart for creating a machine-learned recognition model.

In step S100, a dataset for training is gathered and prepared using the contactless sensor 5. The dataset collected in this step includes SPAD array data captured by the contactless sensor 5, which represents various hand positions, poses, and gestures including hands in different orientations and lighting conditions.

In step S200, a neural network model is built. The neural network model starts with an input layer that accepts the preprocessed images. Then, convolutional layers extract essential features, such as edges and shapes, by applying filters to the images.

These are followed by pooling layers that reduce the spatial size of the data, making the computations more efficient. After several layers of feature extraction, fully connected layers integrate the learned features and make decisions. Finally, the output layer produces the desired outcome, such as detecting the presence of a hand.

In step S300, the model is trained by feeding it labeled images, comparing its predictions to the correct labels, and using an optimization algorithm to adjust the model's internal parameters. This process, called backpropagation, reduces the error in predictions over multiple iterations (epochs). The model is fine-tuned by monitoring its performance on a validation set, ensuring the model is not just memorizing the training data but learning general patterns.

In step S400, the model is evaluated for its accuracy on a separate test set of SPAD array data that the model has not seen before.

The developed machine-learned recognition model is stored in the computer memory 62 of the control unit 6.

While the deep learning technique utilizing neural networks is provided as an example of how to create a machine-learned recognition model, other machine-learning approaches may also be used. These alternative methods may include decision trees, which involve splitting data based on feature values to make predictions; support vector machines, which seek optimal boundaries to classify data; and ensemble methods, which combine multiple models to improve prediction accuracy. Other techniques, such as clustering algorithms, Bayesian networks, or nearest neighbor algorithms, may also be suitable depending on the dataset characteristics.

As described above, in the first embodiment, when the user places the hand near the air vent opening 11a, the hand is detected by the contactless sensor 5, and the airflow direction is controlled so that the air is blown toward the hand of the user. With the vehicle air ventilation system of the first embodiment, the method for adjusting the airflow direction is intuitive, making it easy for users to understand and execute correctly. In addition, by setting the direction of the hand as the airflow direction, the desired airflow direction can be easily specified.

Furthermore, with the vehicle air ventilation system of the first embodiment, the 3D coordinates of the hand inside the passenger compartment can be efficiently and cost-effectively detected using the time-of-flight ranging sensor.

In the first embodiment, the hand of the user is used as an example of a part of a human limb detected by the contactless sensor 5. However, the vehicle air ventilation system may be configured to detect one or more fingers instead of a hand as a part of a human limb.

### Second Embodiment

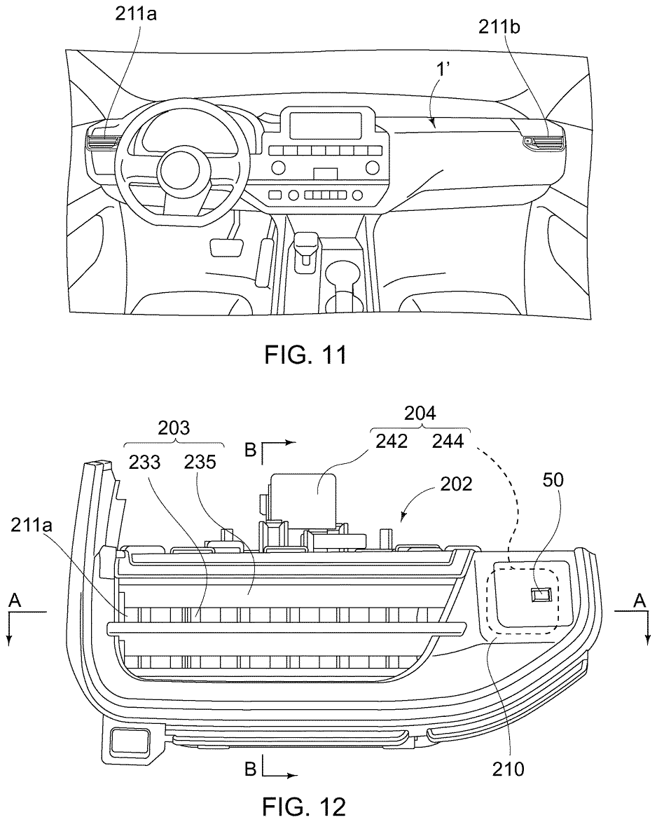

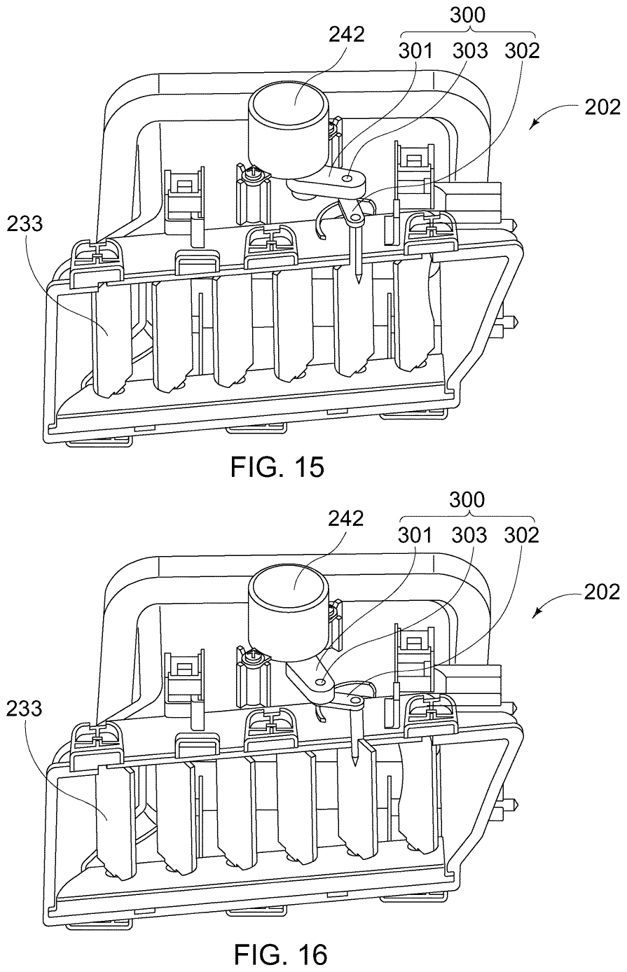

Next, with reference to FIGS. 11-27, a vehicle air ventilation system of a second embodiment of the present disclosure will be described.

The vehicle air ventilation system according to the second embodiment includes an air duct assembly 202, an airflow-adjusting member 203, an actuator unit 204, a contactless sensor 50, and a control unit 206.

As shown in FIG. 11, the passenger compartment of the vehicle includes an instrument panel 1′. In this example, a pair of air vent openings 211a and 211b are provided in the instrument panel 1′ on the left side and the right side in the front portion of the passenger compartment. The instrument panel 1′ may be provided with one or more additional air vent openings. Although not shown, the additional air vent opening(s) may also be provided near the back seats of the vehicle.

Each of the air vent openings 211a and 211b is defined by a frame part 210 that is fixedly coupled to the instrument panel 1′. In the vehicle air ventilation system of the second embodiment, the air duct assembly 202 is arranged behind each of the air vent openings 211a and 211b. The air duct assemblies 202 positioned behind the air vent openings 211a and 211b share the same basic structure, though they may be configured as mirror images of one another depending on design requirements. Therefore, this disclosure will only provide a detailed explanation of the air duct assembly 202 located behind the air vent opening 211a.

FIGS. 12, 13 and 15-20 show an example of the air duct assembly 202 according to the second embodiment. The air duct assembly 202 extends between an inlet end 202a into which a volume of air is directed in an initial air flow direction, and an outlet end 202b at which the volume of air exits the air duct assembly 2. The inlet end 202a of the air duct assembly 202 is connected to a vehicle's HVAC system (not shown), which regulates the temperature, humidity, and other air conditions. The conditioned air from the vehicle's HVAC system is then directed into the passenger compartment through the air duct assembly 202.

The air duct assembly 202 defines an air duct 223 through which the air flows generally in the +X direction from the inlet end 202a to the outlet end 202b. The air flows from the air duct 223 into the passenger compartment via the air vent opening 211a. In the second embodiment, a plurality of movable horizontal vanes 235 are provided at or adjacent to the air vent opening 211a.

The vehicle air ventilation system according to the second embodiment includes an airflow-adjusting member 203 coupled to the air duct assembly 202. The airflow-adjusting member 203 is configured to adjust the airflow from the air duct 223 into the passenger compartment. More specifically, the airflow-adjusting member 203 includes a shutter member 230, a plurality of vertically extending vane parts 233, a plurality of horizontally extending vane parts 235, a linkage mechanism 300 operatively coupled to the vertically extending vane parts 233, and a cam mechanism 400 operatably coupled to the shutter member 230 and the horizontally extending vane parts 233.

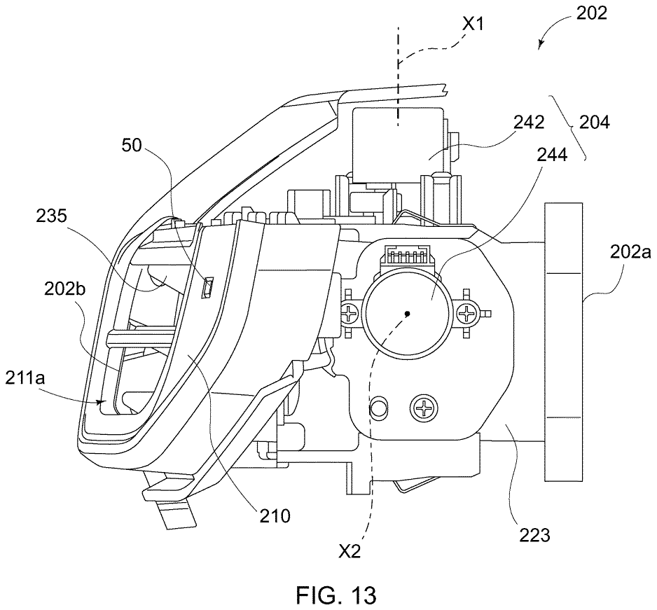

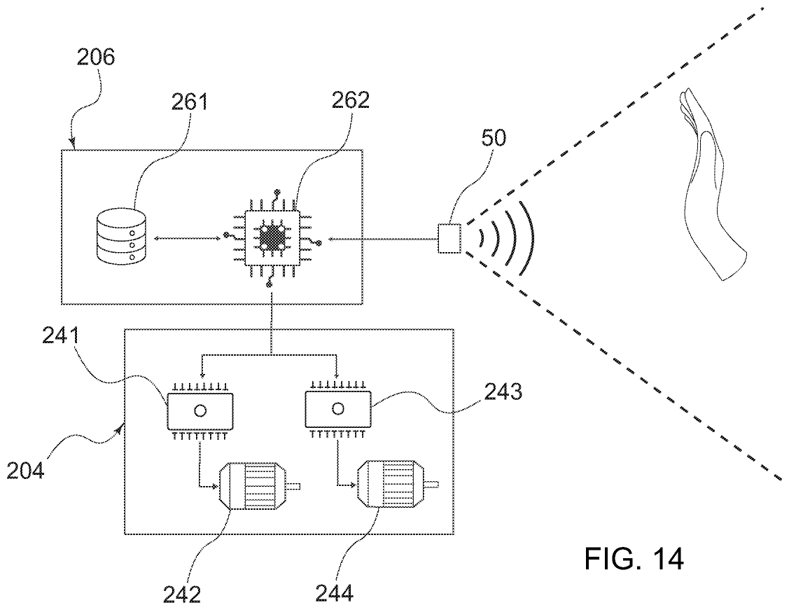

The actuator unit 204 is operatively coupled to the airflow-adjusting member 203 to adjust the airflow. More specifically, as shown in FIG. 14, the actuator unit 204 includes a first motor driver 241, a first motor 242, a second motor driver 243, and a second motor 244. The first motor driver 241 is operatively coupled to the first motor 242, which is operatively coupled to the linkage mechanism 300. As shown in FIG. 13, the first motor 242 has a rotational axis X1. The second motor driver 243 is operatively coupled to the second motor 244, which is operatively coupled to the cam mechanism 400. As shown in FIG. 13, the second motor 244 has a rotational axis X2. The rotational axis X1 of the first motor 242 intersects the rotational axis X2 of the second motor. In the second embodiment, the rotational axis X1 is orthogonal to the rotational axis X2.

The linkage mechanism 300 includes a first linkage arm 301 and a second linkage arm 302. The first linkage arm 301 is configured to rotate with the rotation of the first motor 242. A free end of the first linkage arm 301 is pivotally coupled to a second linkage arm 302 at pivot axis 303. This pivotal coupling allows relative angular displacement between the two linkage arms 301, 302 while maintaining force transmission through the joint. As the first linkage arm 301 rotates as the rotation of the first motor 242, the first linkage arm 301 exerts a pushing and pulling action upon the second linkage arm 302 via the pivot connection. This interaction converts the rotational motion of the first linkage arm 301 into a corresponding angular displacement of the second linkage arm 302. The second linkage arm 302 is fixedly coupled to the pivot point of one of the vertically extending vane parts 233. Because the plurality of vertically extending vane parts 233 are fixedly coupled together to rotate in unison, rotation of the second linkage arm 302 induces simultaneous rotation of all of the vertically extending vane parts 233. The vane parts 233 are configured to direct the airflow generally to left or right, or any intermediate direction therebetween as the air exits the vent opening 211a. In other words, by adjusting the position of the vane parts 233, the airflow direction of the air exiting from the vent opening 21 la can be adjusted in the desired direction with respect to the horizontal direction.

The cam mechanism 400 is a pin-and-slot cam mechanism that is configured to transfer a rotation force of the second motor 244 to selectively drive two different driven plates, namely a first plate 404 and a second plate 406 via a pin-and-slot arrangement. The cam mechanism 400 includes an arm member 401 having a rotation shaft 402 that is coupled to an output shaft of the second motor 244. A pin is mounted near the end of the arm member 401 acting as the cam follower. As the rotation shaft 402 rotates, the arm member 401 rotates and the pin traces a circular path around the rotation shaft 402.

The first plate 404 is mounted on a first pivot axis 403, and the second plate 406 is mounted on a second pivot axis 405 so that the first plate 404 and the second plate 406 are configured to rotate independently.

A linear first groove 404a is formed in the first plate 404, and a linear second groove 406a is formed in the second plate 406. The first groove 404a and the second groove 406a are positioned so that the pin of the arm member 401 can engage with only one of the first groove 404a and the second groove 406a at a time as the arm member 401 passes through different angular positions about the rotation shaft 402. When the pin is not inside the first groove 404a, the first plate 404 remains stationary and mechanically isolated from the rotation shaft 402. When the pin is not inside the second groove 406a, the second plate 406 remains stationary and mechanically isolated from the rotation shaft 402.

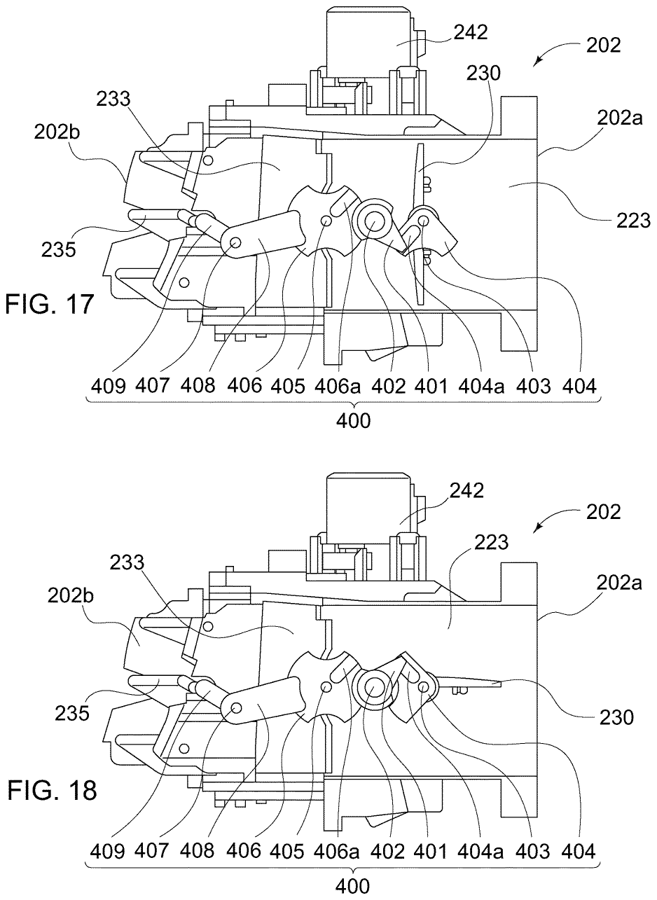

As shown in FIG. 17, when the pin of the arm member 401 aligns with the entrance of the first groove 404a of the first plate 404, the pin enters the first groove 404a and becomes constrained to move along the linear path defined by the first groove 404a. As the arm member 401 continues to rotate, the pin slides within the first groove 404a.

This sliding action generates a force on the groove walls, producing a torque about the first pivot axis 403 and causing the first plate 404 to rotate as shown in FIG. 18. In other words, the pin of the arm member 401 is configured to slidably engage with the first groove 404a when the arm member 401 is positioned within a first angular sector (the angular sector between the positions of the arm member 401 in FIGS. 17 and 18) with respect to the rotation shaft 402 to rotate the first plate 404 about the first pivot axis 403. The first plate 404 is fixedly coupled to the shutter member 230 so that the rotation of the first plate 404 about the first pivot axis 403 causes rotation of the shutter member 230 about the first pivot axis 403 as shown in FIGS. 17 and 18.

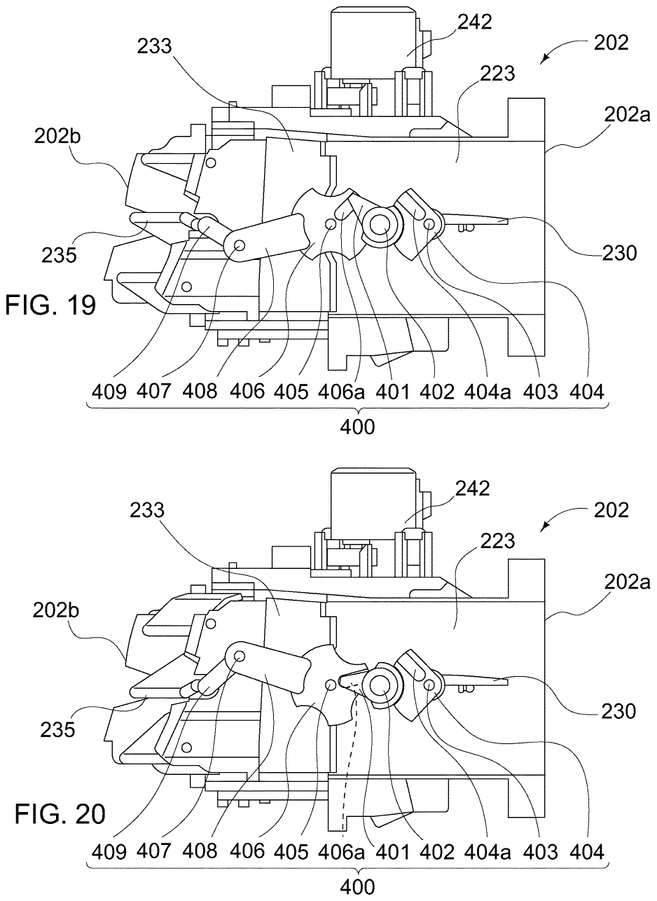

As shown in FIG. 19, when the pin of the arm member 401 aligns with the entrance of the second groove 406a of the second plate 406, the pin enters the second groove 406a and becomes constrained to move along the linear path defined by the second groove 406a. As the arm member 401 continues to rotate, the pin slides within the second groove 406a. This sliding action generates a force on the groove walls, producing a torque about the second pivot axis 405 and causing the second plate 406 to rotate as shown in FIG. 20. The second plate 406 is fixedly coupled to a first link arm 408 such that rotation of the second plate 406 results in corresponding rotation of the first link arm 408 about the second pivot axis 405. A free end of the first link arm 408 is pivotally coupled to a second link arm 409 at a pivot axis 407. This pivotal coupling allows relative angular displacement between the two link arms while maintaining force transmission through the joint. As the first link arm 408 rotates in response to the movement of the second plate 406, the first link arm 408 exerts a pushing and pulling action upon the second link arm 409 via the pivot connection. This interaction converts the rotational motion of the first link arm 408 into a corresponding angular displacement of the second link arm 409 as shown in FIG. 20. Accordingly, the pin of the arm member 401 slidably engages with the second groove 406a when the arm member 401 is positioned within a second angular sector (the angular sector between the positions of the arm member 401 in FIGS. 19 and 20) with respect to the rotation shaft 42 to rotate the second plate 406 about the second pivot axis 405.

The second link arm 409 is fixedly coupled to the pivot point of one of the horizontally extending vane parts 235. Because the plurality of horizontally extending vane parts 235 are fixedly coupled together to rotate in unison, rotation of the second link arm 409 induces simultaneous rotation of all of the horizontally extending vane parts 235.

The horizontally extending vane parts 235 are configured to direct the airflow generally to up or down, or any intermediate direction therebetween as the air exits the outlet opening 224. In other words, by adjusting the position of the vane parts 235, the airflow direction of the air exiting from the outlet opening 224 can be adjusted in the desired direction with respect to the vertical direction.

Accordingly, the cam mechanism 400 is designed to convert a single rotational input, supplied through the rotation shaft 402, into two separate and independent rotational outputs. This is achieved through a pin-and-slot structure in which the arm member 401 mounted on the rotation shaft 402 carries the pin that traces a circular path as the rotation shaft 402 rotates. As the pin travels along this circular path, it selectively engages the first groove 404a in the first plate 404 or the second groove 406a in the second plate 406 depending on its angular position around the rotation shaft 402.

This configuration of the cam mechanism 400 provides a mechanical advantage by eliminating the need for separate motors to drive the shutter member 230 and the horizontally extending vanes 235. Instead, a single actuator can control both of the shutter member 230 and the horizontally extending vanes 235 without cross-interference. The cam mechanism 400 ensures that only one of the first plate 404 and the second plate 406 is driven at a time, while the other remains stationary and mechanically isolated from the rotation shaft 402 when its corresponding groove is not engaged. As a result, the system delivers precise control over multiple components while maintaining simplicity, compactness, and mechanical reliability.

The amount of rotation imparted to each of the first plate 404 and the second 406 depends on the configuration of the corresponding one of the first groove 404a and the second groove 406a (i.e., the groove's length, orientation, and distance from the pivot axis of the plate) as well as the radius of the circular path of the pin of the arm member 401.

In the second embodiment, the first motor 242 and the second motor 244 are stepper motors to enable precise control of the positions of the linkage mechanism 300 and the cam mechanism 400. However, a conventional motor other than a stepper motor may be used as the first motor 242 or the second motor 244 as long as the position adjustment of the linkage mechanism 300 and the cam mechanism 400 can be sufficiently executed by controlling the motor. Moreover, other types of conventional actuator mechanisms, rather than a rotational motor, may be utilized to control the linkage mechanism 300 and the cam mechanism 400.

In the vehicle air ventilation system according to the second embodiment, the contactless sensor 50 is mounted adjacent to the vent opening 211a. More specifically, the contactless sensor 50 is mounted at a position overlapping the second motor 244 when seen along the X-axis direction as shown in FIG. 12.

The contactless sensor 50 is configured to detect the position of an object within a prescribed region, which is adjacent to the vent opening 211a in the passenger compartment. The prescribed region is defined so that the contactless sensor 50 can identify objects placed near the air vent opening 211a of the instrument panel 1′. The dimension of the prescribed region R can be adjusted according to the design requirements and consideration of the vehicle.

In the second embodiment, the contactless sensor 50 may be a contactless gesture recognition sensor, such as the PAJ7620U2 and APDS-9960, that is configured to operate by optically detecting hand motion within a short range and internally converting that motion into discrete gesture commands. This type of sensor integrates an infrared (IR) light source and multiple photodetectors. The infrared light illuminates the space in front of the sensor, and when a hand moves through this region, part of the emitted light is reflected back toward the detectors. The spatial and temporal changes in the reflected light intensity provide information about the direction and nature of the hand movement. From these changes, characteristic features associated with predefined gestures, such as left, right, up, down, circle clockwise, circle counter-clockwise, or forward movements, are extracted and classified using built-in algorithms. As a result, the sensor outputs a simple digital gesture code rather than raw optical data, which allows a host microcontroller to interpret gestures with minimal computational overhead.

The contactless sensor 50 is operatively connected to the control unit 206.

Communication between the contactless sensor 50 and the control unit 206 may be performed through a low-speed digital interface such as I²C. The control unit 206 is configured to periodically read registers that indicate whether a valid gesture has been recognized. Because the gesture recognition is handled internally in the contactless sensor 50 in the second embodiment, system design is simplified and power consumption remains relatively low.

The control unit 206 is configured to activate the actuator unit 204 to move the airflow-adjusting member 203 to adjust the airflow when the control unit 206 determines that the object is the part of the human limb. More specifically, in the second embodiment, the control unit 206 is configured to receive the output signal indicative of the hand gesture from the contactless sensor 50, and the control unit 206 is configured to control the actuator unit 204 to move the linkage mechanism 300 and the cam mechanism 400 to direct the airflow in the desired direction based on the detected hand gesture.

In the second embodiment, the control unit 206 includes an electronic control unit or controller 261 (e.g., a processor) and a computer memory 262. The electronic controller 261 includes one or more processor(s) for controlling the various operations of the vehicle air ventilation system, as will be further described. In the second embodiment, the electronic controller 261 is preferably a microcontroller including a microcomputer (MPU) or central processing unit (CPU). The electronic controller 261 is formed of one or more semiconductor chips that are mounted on a circuit board. The term “electronic control unit” or “electronic controller” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 261.

The computer memory 262 is any memory or storage device. Here, for example, the computer memory 262 includes a transitory or non-transitory computer-readable medium with the sole exception of a transitory propagating signal. Thus, the computer memory 262 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The computer memory 262 stores various control processes or control programs as well as information or data used by the electronic controller 261. Thus, the computer memory 262 is electrically connected to the electronic controller 261. In this way, the electronic controller 261 can retrieve data and access programs stored in the computer memory 262, and can store data to the computer memory 262. As explained below, the computer memory 262 preferably includes non-volatile memory that is configured to store various control programs (e.g., a program for an airflow adjustment control method, etc.), operational data, component identification data, etc.

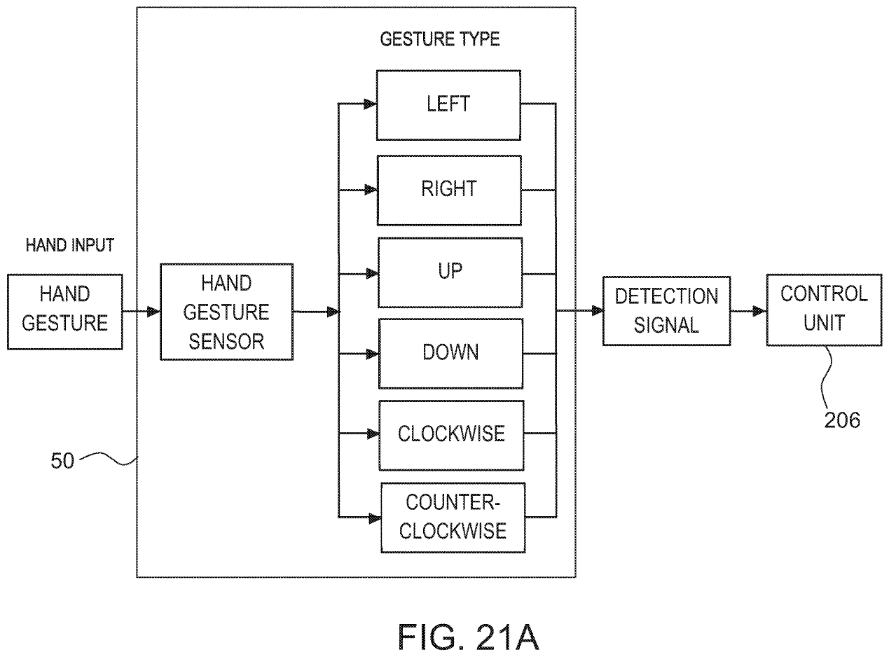

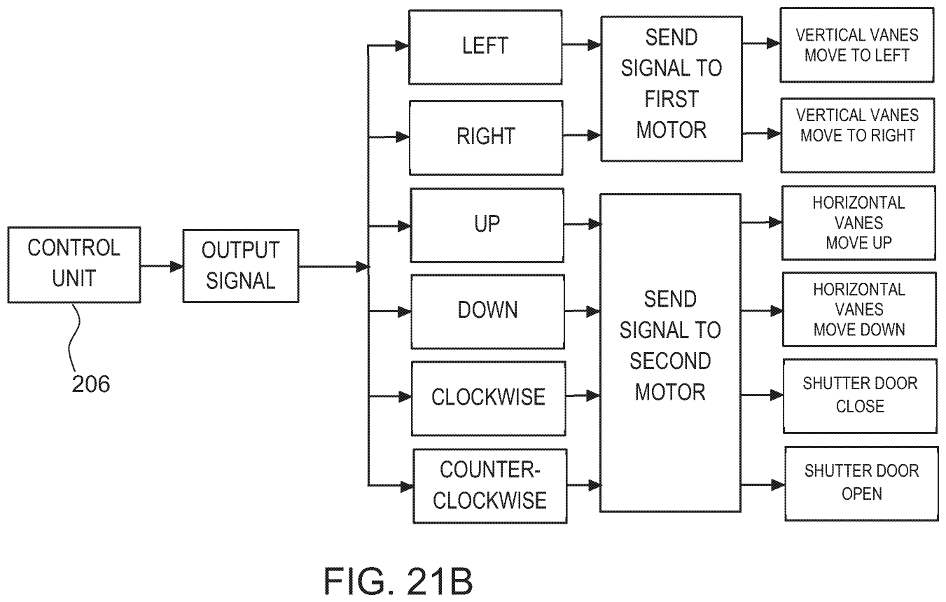

FIGS. 21A and 21B are block diagrams illustrating an airflow adjustment control according to the second embodiment.

As shown in FIG. 21A, when the user move his/her hand near the contactless sensor 50, the built-in processing in the contactless sensor 50 compares the detected movement to known patterns to determine whether the hand is moved in one of the following directions: left, right, up, down, circle clockwise, and circle counter-clockwise. The contactless sensor 50 outputs a detection signal indicative of the detected gesture, which is sent the control unit 206.

As shown in FIG. 21B, once the control unit 206 receives the detection signal from the contactless sensor 50, the control unit 206 is configured to determine angles/motor steps required to move the shutter member 230, the vertically extending vane parts 233, and/or the horizontally extending vane parts 235 from the current positions to direct the airflow according to the gesture detected by the contactless sensor 50. As in the first embodiment, the control unit 206 records the updated positions of the shutter member 230, the vertically extending vane parts 233, and/or the horizontally extending vane parts 235.

In the second embodiment, each detected hand-movement direction corresponds to a specific airflow-control instruction. For example, a leftward hand motion directs the airflow to the left; a rightward motion directs it to the right; an upward motion directs the airflow upward; and a downward motion directs it downward. A clockwise circular gesture stops the airflow, while a counterclockwise circular gesture reactivates it.

By assigning distinct airflow-control operations to easily recognizable hand motions, the user can operate the ventilation system without physically touching any switches, knobs, or vanes. This not only enhances user convenience but also contributes to improved safety by allowing adjustments without diverting attention from driving.

Moreover, the system architecture allows gesture assignments to be easily reconfigured or expanded. The correspondence between gestures and airflow-control behaviors can be modified, expanded, or supplemented to support various airflow modes, HVAC functions, or other vehicular features. In this way, the gesture-based interface provides a highly adaptable control framework capable of supporting a broad range of gesture-driven functions.

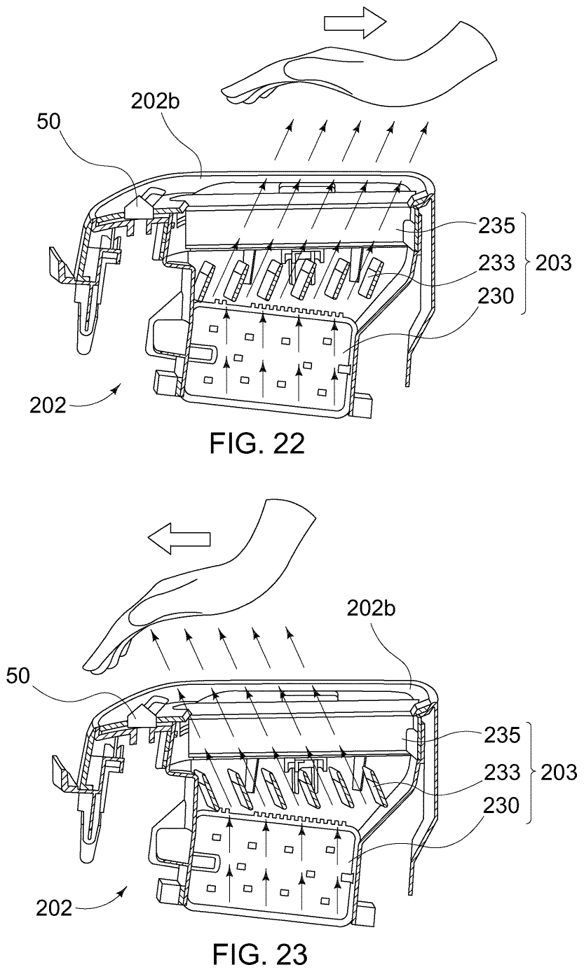

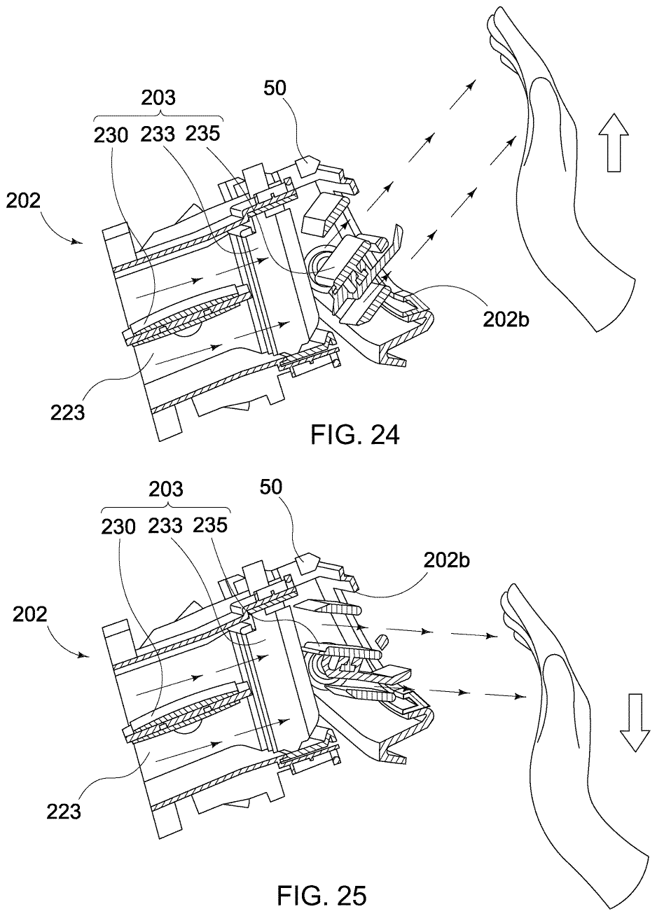

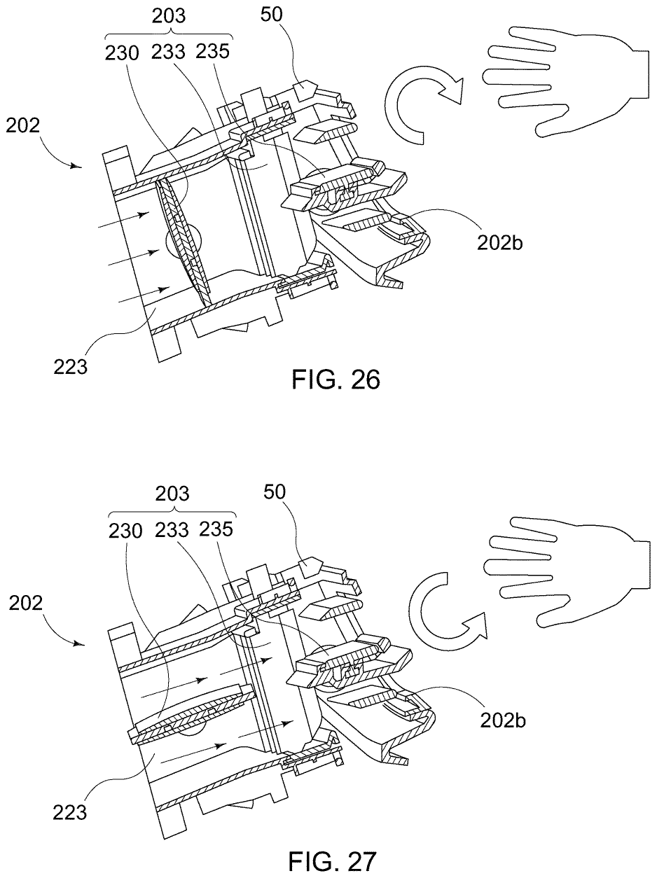

As shown in FIG. 21B, the control unit 206 sends an output signal to the actuator unit 204 to control the first motor 242 or the second motor 244 according to the detected gesture. FIGS. 22-26 schematically illustrate how the positions of the airflow-adjusting member 203 (including the shutter member 230, the vertically extending vane parts 233, and the horizontally extending vane parts 235) are varied to direct the airflow in accordance with the user's hand gesture. When the detected gesture is the left motion, the control unit 206 is configured to control the actuator unit 204 to rotate the first motor 242 to move the vertical vanes 233 toward left (FIG. 22). When the detected gesture is the right motion, the control unit 206 is configured to control the actuator unit 204 to rotate the first motor 242 to move the vertical vanes 233 toward right (FIG. 23). When the detected gesture is the upward motion, the control unit 206 is configured to control the actuator unit 204 to rotate the second motor 244 to move the horizontal vanes 235 toward up (FIG. 24). When the detected gesture is the downward motion, the control unit 206 is configured to control the actuator unit 204 to rotate the second motor 244 to move the horizontal vanes 235 toward down (FIG. 25). When the detected gesture is the clockwise circular gesture, the control unit 206 is configured to control the actuator unit 204 to rotate the second motor 244 to close the shutter member 230 (FIG. 26). When the detected gesture is the counter-clockwise circular gesture, the control unit 206 is configured to control the actuator unit 204 to rotate the second motor 244 to open the shutter member 230 (FIG. 27).

As described above, in the second embodiment, when the user places the hand near the air vent opening 11a, the hand is detected by the contactless sensor 50, and the airflow direction is controlled according to the hand gesture detected by the contactless sensor 50. With the vehicle air ventilation system of the second embodiment, the method for adjusting the airflow direction is intuitive, making it easy for users to understand and execute correctly. In addition, because the gesture recognition is handled internally in the contactless sensor 50 in the second embodiment, system design is simplified and power consumption remains relatively low.

Although the contactless sensor 50 in the second embodiment is explained as an example of a contactless gesture recognition sensor, alternative sensor technologies can be used as the contactless sensor 50. Optical gesture sensors similar in principle may integrate ambient light or color sensing functions in addition to gesture detection. Time-of-flight (ToF) distance sensors use modulated light or laser pulses to measure depth and can infer gestures by tracking changes in distance over time, although gesture recognition must usually be implemented in the host processor. Radar-based sensors, particularly millimeter-wave devices, detect motion using Doppler and range information and can operate reliably in darkness or challenging lighting conditions. Capacitive or electric-field sensors offer another alternative by detecting disturbances in an electric field caused by a nearby hand, enabling short-range, low-power gesture detection without relying on optical methods.

In the illustrated embodiments as described above, the vehicle air ventilation system is configured to adjust the airflow direction based on the data collected by the contactless sensor 5, 50. Nevertheless, the vehicle air ventilation system can also be configured to adjust other factors, such as air volume, air temperature, HVAC system activation, and more, in addition to or instead of altering the airflow direction. In such scenarios, the control unit 6, 206 is operatively coupled the vehicle's HVAC system to make the necessary adjustments based on the data collected by the contactless sensor 5, 50. Moreover, the control unit 6, 206 and the contactless sensor 5, 50 can be configured to recognize various finger/hand patterns or gestures, each of which could be correlated with controlling different parameters.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle air ventilation system. Accordingly, these terms, as utilized to describe the present invention should be interpreted relative to a vehicle equipped with the vehicle air ventilation system. Also as used herein to describe the above embodiment(s), the terms “upstream” and “downstream” refer to the direction with respect to the airflow that flows from the in the vehicle air ventilation system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle air ventilation system configured to control air flowing into a passenger compartment of a vehicle, the vehicle air ventilation system comprising:
an air duct assembly defining an air duct and a vent opening through which air flows from the air duct into the passenger compartment, and
an airflow-adjusting member coupled to the air duct assembly, and configured to adjust an airflow from the air duct into the passenger compartment,
an actuator unit operatively coupled to the airflow-adjusting member to control the airflow-adjusting member to adjust the airflow;
a contactless sensor configured to detect a gesture of a hand located within a prescribed region adjacent to the vent opening in the passenger compartment, and to output a detection signal indicative of the gesture; and
a control unit configured to receive the detection signal and to control the actuator unit to move the airflow-adjusting member to adjust the airflow based on the gesture detected by the contactless sensor.

2. The vehicle air ventilation system according to claim 1, wherein
the airflow-adjusting member includes
a shutter member,
a vertical vane part, and
a horizonal vane part, and
the actuator unit includes a motor configured to independently move at least two of the shutter member, the vertical vane part, and the horizontal vane part.

3. The vehicle air ventilation system according to claim 2, wherein
the actuator unit further includes a cam mechanism configured to be driven by the motor, the cam mechanism including
a first plate defining a first groove, the first plate being rotatable about a first pivot axis,
a second plate defining a second groove, the second plate being rotatable about a second pivot axis, and
an arm member fixed to a rotation shaft of the first motor, the arm member having a pin configured to slidably engage with the first groove when the arm member is positioned within a first angular sector with respect to the rotation shaft to rotate the first plate about the first pivot axis, and to slidably engage with the second groove when the arm member is positioned within a second angular sector with respect to the rotation shaft to rotate the second plate about the second pivot axis.

4. The vehicle air ventilation system according to claim 3, wherein
the first plate is fixed to the shutter member, and
the second plate is fixed to the horizontal vane part.

5. The vehicle air ventilation system according to claim 3, wherein
the first pivot axis is parallel to the second pivot axis.

6. The vehicle air ventilation system according to claim 4, wherein
the actuator unit further includes an additional motor configured to move the vertical vane part.

7. The vehicle air ventilation system according to claim 6, wherein
a rotational axis direction of the motor intersects a rotational axis direction of the additional motor.

8. The vehicle air ventilation system according to claim 1, wherein
the contactless sensor is a gesture recognition sensor configured to detect the gesture of the hand by capturing infrared light reflections from the hand and processing data to recognize the gesture.

9. The vehicle air ventilation system according to claim 2, wherein
the motor overlaps the contactless sensor when viewed along a direction orthogonal to a rotational axis of the motor.

10. A vehicle air ventilation system configured to control air flowing into a passenger compartment of a vehicle, the vehicle air ventilation system comprising:
an air duct assembly defining an air duct and an outlet opening through which air flows from the air duct into the passenger compartment, the air duct assembly including a partition part disposed upstream of the outlet opening to divide an airway into a first channel and a second channel, and
an airflow-adjusting member coupled to the air duct assembly, and configured to adjust an airflow from the air duct into the passenger compartment,
an actuator unit operatively coupled to the airflow-adjusting member to control the airflow-adjusting member to adjust the airflow;
a contactless sensor mounted to a downstream end portion of the partition part, and configured to detect a position of an object located within a prescribed region adjacent to the outlet opening in the passenger compartment; and
a control unit configured to determine whether the object detected by the contactless sensor is a part of a human limb based on output data from the contactless sensor, and to activate the actuator unit to move the airflow-adjusting member to adjust the airflow when the control unit determines that the object is the part of the human limb.

11. The vehicle air ventilation system according to claim 10, wherein
the airflow-adjusting member includes an airflow-directing part movably coupled to an upstream end portion of the partition part of the air duct assembly, and configured to adjust a volume of the airflow directed into each of the first channel and the second channel.

12. The vehicle air ventilation system according to claim 11, wherein
the control unit is configured to determine the object detected by the contactless sensor is the part of the human limb including a hand of a user, and
the control unit is configured to control the actuator unit to move the airflow-directing part to direct the airflow toward the hand of the user.

13. The vehicle air ventilation system according to claim 12, wherein
the airflow-adjusting member includes at least one vane part rotationally attached to the partition part of the air duct assembly at a position between an inlet end and an outlet end of the air duct assembly between an upstream end portion and a downstream end portion of the partition part, and upstream of the contactless sensor.

14. The vehicle air ventilation system according to claim 13, wherein
the control unit is configured to determine the object detected by the contactless sensor is the part of the human limb including a hand of a user, and
the control unit is configured to control the actuator unit to move the at least one vane to direct the airflow toward the hand of the user.

15. The vehicle air ventilation system according to claim 13, wherein
the at least one vane part includes a first vane section disposed within the first channel and a second vane section disposed within the second channel.

16. The vehicle air ventilation system according to claim 11, wherein
the airflow-adjusting member further includes at least one vane rotationally attached to the partition member of the air duct assembly at a position between an upstream end portion and a downstream end portion of the partition part, and upstream of the contactless sensor.

17. The vehicle air ventilation system according to claim 16, wherein
the control unit is configured to determine the object detected by the contactless sensor is the part of the human limb including a hand of a user, and
the control unit is configured to control the actuator unit to move the airflow-directing part to direct the airflow toward the hand of the user.

18. A vehicle air ventilation system configured to control air flowing into a passenger compartment of a vehicle, the vehicle air ventilation system comprising:
an air duct assembly defining an air duct and an outlet opening through which air flows from the air duct into the passenger compartment, and
an airflow-adjusting member coupled to the air duct assembly, and configured to adjust an airflow from the air duct into the passenger compartment,
an actuator unit operatively coupled to the airflow-adjusting member to control the airflow-adjusting member to adjust the airflow;
a contactless sensor configured to detect a position of an object located within a prescribed region adjacent to the outlet opening in the passenger compartment, the contactless sensor being a time-of-flight ranging sensor; and
a control unit configured to determine whether the object detected by the contactless sensor is a part of a human limb by applying a machine-learned recognition model to the output data from the contactless sensor, and to activate the actuator unit to move the airflow-adjusting member to adjust the airflow when the control unit determines that the object is the part of the human limb.

19. The vehicle air ventilation system according to claim 18, wherein
the contactless sensor is mounted within the outlet opening.
